(19) United States
(12) Patent Application Publication
(10) Pub. No.: US 2024/0056447 A1
(43) Pub. Date: Feb. 15, 2024

(54) ELECTRONIC SYSTEM FOR IMPLEMENTING INTERCONNECTIONS AND AUTHENTICATING PERMISSIONS BETWEEN RESOURCE COMPONENTS

(71) Applicant: BANK OF AMERICA CORPORATION, Charlotte, NC (US)

(72) Inventors: Pierre Jacques Bouchard, Davidson, NC (US); Lakshminarayana Vishnubhotla, Skillman, NJ (US); John L. Reilly, Charlotte, NC (US); Manu Jacob Kurian, Dallas, TX (US)

(73) Assignee: BANK OF AMERICA CORPORATION, Charlotte, NC (US)

(21) Appl. No.: 17/887,152

(22) Filed: Aug. 12, 2022

(51) Int. Cl. H04L 9/40; H04L 41/12

(52) U.S. Cl. CPC H04L 63/10; H04L 41/12

(57) ABSTRACT

Systems, computer program products, and methods are described herein for implementing interconnections and authenticating permissions between resource components. The present invention is configured to establishing a network resource component database that may include, for each network resource associated with the network, network resource component-level specifications and associated component signatures. The system may then receive a request for a new network resource to connect to a first network resource. The system may then determine a component signature of the new network resource and compare the component signature of the new network resource against the component signature of the first network resource to determine whether the new network resource and the first network resource are compatible within the network.

### FIELD OF THE INVENTION

The present invention embraces a system for implementing interconnections and authenticating permissions between resource components.

### BACKGROUND

Current systems for managing interconnections between network resources do not have a sophisticated understanding of how two or more network resources are interconnected. As such, when one network resource is updated, upgraded, replaced, or otherwise changed, these legacy systems do not accurately identify the cross-correlation impacts between the changed network resource and other network resources within an enterprise environment.

There are some current systems that track interconnections between two or more network resources (i.e., with a view to each network resource as a whole) to identify when a change to one network resource might impact one or more other network resources. However, these systems do not represent a true understanding of the complicated cross-correlation impacts of the individual components of each separate network resource. As such, these current systems can be inaccurate, identifying potential impacts to a network resource based on a change to a different network resource when no impact is present. Similarly, these current systems can be inaccurate by not capturing and analyzing multi-level interconnectivity between components of multiple network resources. As such, there is a need for establishing an electronic system for implementing interconnections and authenticating permissions between resource components.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the present invention address the above needs and/or achieve other advantages by providing apparatuses (e.g., a system, computer program product and/or other devices) and methods for implementing interconnections and authenticating permissions between resource components. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve establishing a network resource component database comprising, for each network resource associated with the network, network resource component-level specifications and associated component signatures. The system may then receive a request for a new network resource to connect to a first network resource and determine a component signature of the new network resource. The system can then compare the component signature of the new network resource against a component signature of the first network resource to determine whether the new network resource and the first network resource are compatible within the network.

In some embodiments, the system may then determine that the component signature of the new network resource matches the component signature of the first network resource. In response to determining that the component signature of the new network resource matches the component signature of the first network resource, the system may grant permission to connect the new network resource to the first network resource and store network resource component information for the new network resource in the network resource component database.

Alternatively, the system may determine that the component signature of the new network resource does not match the component signature of the first network resource. In response to determining that the component signature of the new network resource does not match the component signature of the first network resource, the system may reject the request for the new network resource to connect to the first network resource. The system may then transmit an alert identifying the incompatible network resource components of the new network resource and the first network resource to a computing device of a user associated with the network resource component database.

The network resource component-level specifications of this system may, in some embodiments, comprise descriptive information, permissions information, and known interconnectivity attributes of each network resource component within the network.

The new network resource of this system may, in some embodiments, comprise a network resource that previously existed on the network, and which has been updated, upgraded, or changed from its previous iteration at a network resource component level.

The network resource components of this system may, in some embodiments, comprise one or more programs, algorithms, modules, data transfer utilities, device drivers, operating systems, plugins, application program interfaces, web resources, data libraries, data repositories, network resource license right, network resource licensed seat information, network resource version information, network resource patch status information, a physical location of a device associated with network resources, authorized users associated with network resources, and authorized devices associated with network resources.

In some embodiments of this system, the step of determining the component signature for the new network resource comprises compiling network resource component-level specifications for the new network resource into one or more data elements that can be communicated by a handshake process.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for implementing interconnections and authenticating permissions between resource components, in accordance with an embodiment of the invention;

FIG. 2 illustrates a process flow for implementing interconnections and authenticating permissions between resource components, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to software applications, software programs, software modules, and the like, whether run locally on user devices, run on a remote server for the use of multiple users (e.g., as a software-as-a-service solution), run on internal servers of an entity, or the like. The resources may additionally include data repositories or libraries, data transfer utilities, data lakes, third party software, application program interfaces, and the like.

The invention described herein comprises the establishment and management of a network resource component database that implements interconnections and authentication permissions between resource components of an enterprise network.

Current systems for managing interconnections between network resources do not have a sophisticated understanding of how two or more network resources are interconnected. As such, when one network resource is updated, upgraded, replaced, or otherwise changed, these legacy systems do not accurately identify the cross-correlation impacts between the changed network resource and other network resources within an enterprise environment.

There are some current systems that track interconnections between two or more network resources (i.e., with a view to each network resource as a whole) to identify when a change to one network resource might impact one or more other network resources. However, these systems do not represent a true understanding of the complicated cross-correlation impacts of the individual components of each separate network resource. As such, these current systems can be inaccurate, identifying potential impacts to a network resource based on a change to a different network resource when no impact is present. Similarly, these current systems can be inaccurate by not capturing and analyzing multi-level interconnectivity between components of multiple network resources.

For example, two network resources may generally be linked or permitted to connect to each other, both from an authorization and a compatibility standpoint. However, if one seemingly minor component of one of these network resources changes (e.g., a change in physical location of a device on which the network resource is installed, a change to software licensing rights or software seat license rights, a change to a version of a module, plugin, or library that is a feature of that resource, or the like), then that change may impact how that network resource interacts or connects with the other network resource. As such, there is a need for establishing an electronic system for implementing interconnections and authenticating permissions between the components of network resources, and not just the network resources themselves.

The present invention involves establishing an enterprise-level network resource component database that acts like a map of the network's software applications at a detailed software-component level. This “map” tracks information about each software application within the overall system by storing information at software component and sub-component levels. Further, for each software application on the system, this invention determines or otherwise manages permissions, system requirements, software license requirements, and other interconnections between that software application's individual components and the other software applications and the other software applications' components in the system.

When a new software application is introduced to the system environment, or otherwise initiates an interaction with one of the software applications currently within the system environment, a handshake based on the individual software component-specific information can occur to determine whether the new software application is authorized to connect (i.e., communicate, interact, or the like) or is otherwise compatible with the other software applications in the overall system.

The network resource component database can be dynamically updated on a resource component level in real time or near-real time as network resources change, as network resource components change, as security parameters change, and as permissions change across the network. These updates may be asynchronous, in that the network resource component database does not need to be actively updated to record interconnection information between the changed network resource (or network resource component). Instead, the network resource component database can be updated at just the component level for the added, changed, or updated network resource, and that change automatically adjusts the permissions and authentications associated with that network resource and its network resource components throughout the entire network. In this way, the interconnections between the network resource components can be dynamically updated to maintain a real time, or near real time map of cross-correlations between the network resources that understands and can address the impacts of changes made at the component level. The interactions may be identified, determined, added, linked, or otherwise recorded with the network resource component database by artificial intelligence or machine learning engines that analyze the network resource components and their specifications, handshake elements, linked network resources, and the like over time.

The component-level maintenance and analysis of network resources within an overall system or network promotes security and processing abilities of the overall system or network. For example, security-based requirements (e.g., based on user permissions, compliance requirements, device-based permissions, and the like) can be stored on a network resource component level, such that any network resource that the system can regulate whether a specific network resource component interacts with a different network resource component based on a determination as to whether each of the network resource components have met the requisite security requirements of the other network resource components. These permissions may allow access to the network resources and components that are linked together within the network resource component database or map, while denying access to network resources and components that do not share any links. These permissions may be embedded within the network resource component databases or maps, which is especially beneficial for the management of macro-service software frameworks and architecture to build security and improve processing based on the better understanding and application of interconnections between the disparate network resource components of the system.

Using an enterprise-wide network resource component database (e.g., based on an enterprise level software bill of materials system), the software component-specific characteristics (including permissions and security requirements) are dynamically maintained and analyzed. When a software application is added to the network, or when an existing application is updated or upgraded (even at a component level), the system analyzes the component-specific characteristics of that added or changed application.

Based on the component-level analysis, the system can generate data elements for use in “handshakes” with other applications in the network. For each software application that the new or changed application interacts with, the applications can use the handshake to determine whether the two software applications are compatible, both form a security and a general permissions standpoint. As the handshake elements are based upon component-specific information (and not overall application-specific information), the system provides an added and improved layer of security and improved accuracy in processing ability.

What is more, the present invention provides a technical solution to a technical problem. As described herein, the technical problem includes inaccuracies in managing interconnections between software applications that open the overall network to security concerns and break-downs in processing capabilities. From a security standpoint, legacy systems analyze software security links at the software application level, but may not identify changes to the software security due to changes to sub-components of those software applications. Similarly, from a permissions or authentication standpoint, legacy systems again analyze whether one software application has permissions to communicate with or otherwise be linked to a second software application at the overall software application level, but may not identify a change to user or device permissions or authentications that arises due to a change to one sub-component of one of these software applications. The technical solution presented herein allows for software component-level analysis, permission linkages, and security analysis that tracks and regulates the actual interconnectivity of separate software applications in an overall network based on software application component-specific characteristics and rules. In particular, the described network resource component database is an improvement over existing solutions to the software permission and security management programs, (i) providing a more accurate solution to problem, thus reducing the number of resources required to remedy any errors made due to a less accurate solution, (ii) removing manual input and waste from the implementation of the solution, thus improving speed and efficiency of the process and conserving computing resources, and (iii) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

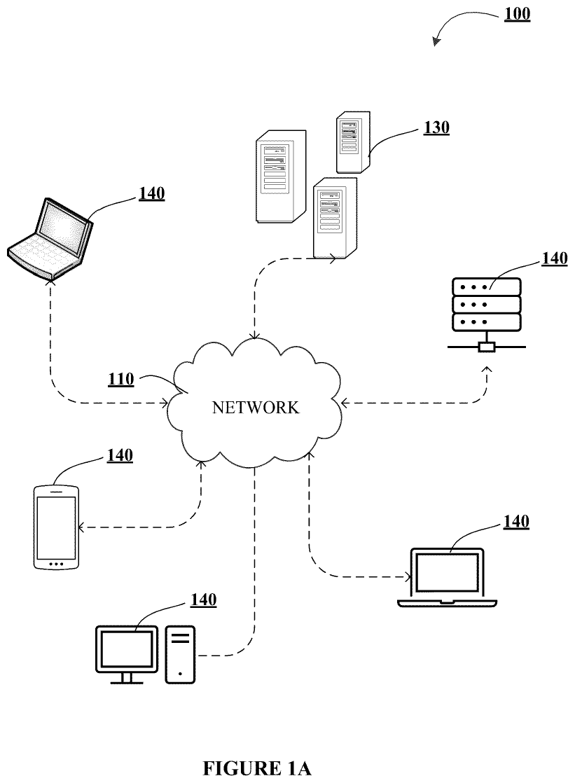

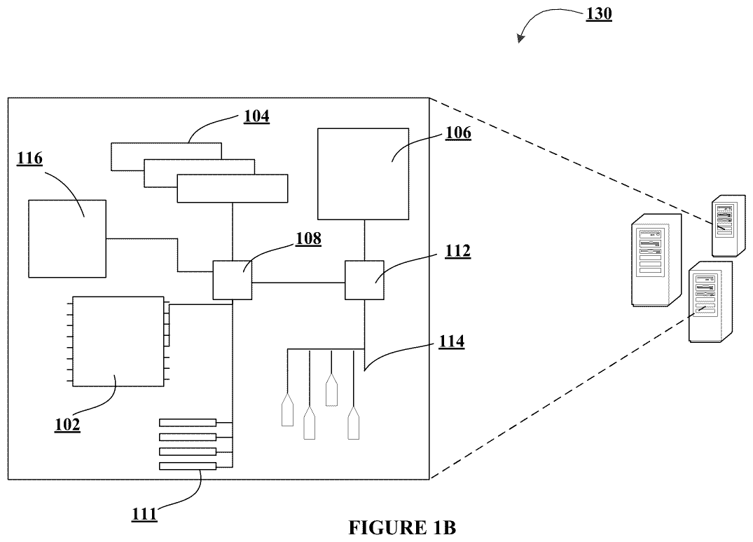

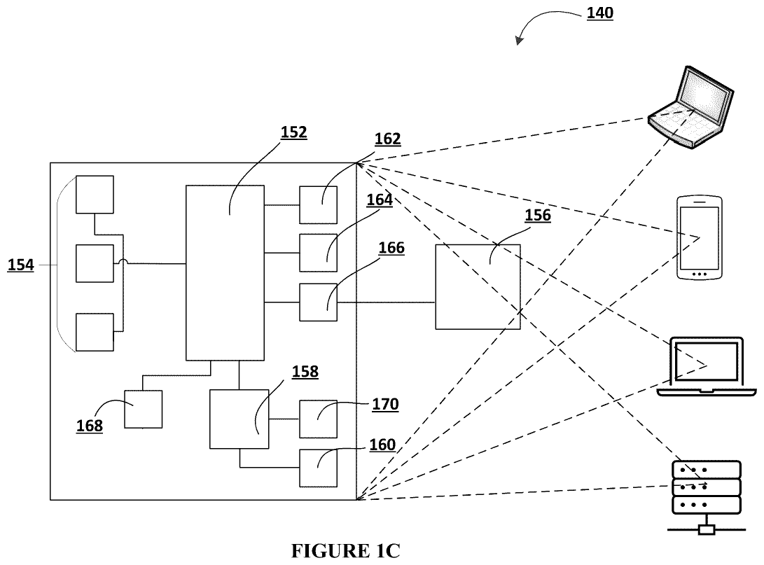

FIGS. 1A-1C illustrate technical components of an exemplary distributed computing environment for implementing interconnections and authenticating permissions between resource components 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, and the like) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

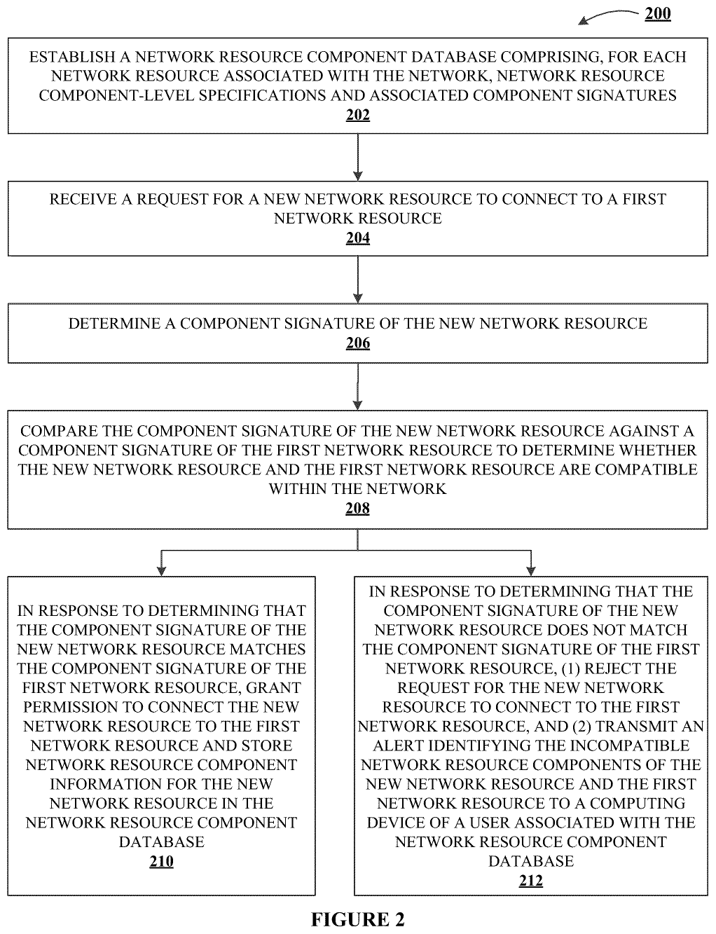

Referring now to FIG. 2, a flowchart is provided to illustrate one embodiment of a process 200 for implementing interconnections and authenticating permissions between resource components, in accordance with embodiments of the invention. In some embodiments, the process 200 may include block 202, where the system establishes a network resource component database comprising, for each network resource associated with the network, network resource component-level specifications and associated component signatures. In some embodiments, the network resource component database comprises a “validated network resource component library,” as described in more detail in the commonly assigned U.S. patent application Ser. No. ______ entitled “ELECTRONIC SECURITY SYSTEM OF NETWORK RESOURCE COMPONENT TRACKING AND ANALYSIS ACROSS A DISTRIBUTED NETWORK AND CONSTRUCTION OF A VALIDATED NETWORK RESOURCE COMPONENT LIBRARY.” Additionally or alternatively, the network resource component database comprises an “electronic system for dynamic adapted security analysis of network resource components,” as described in more detail in the commonly assigned U.S. patent application Ser. No. ______ entitled “ELECTRONIC SYSTEM FOR DYNAMIC ADAPTED SECURITY ANALYSIS OF NETWORK RESOURCE COMPONENTS.”

The network resource components generally comprise component-level or element-level aspects of a larger software application, as well as security, permissions, authentication, authorization, location, contract, and other enterprise constructs that are associated with the software application as a whole and/or each individual component of that software application. Examples of network resource components include, but are not limited to, programs, algorithms, modules, data transfer utilities, device drivers, operating systems, plugins, application program interfaces, web resources, data libraries, data repositories, network resource license right, network resource licensed seat information, network resource version information, network resource patch status information, a physical location of a device associated with network resources, authorized users associated with network resources, and authorized devices associated with network resources.

The network resource component-level specifications may, in some embodiments, comprise descriptive information, permissions information, and known interconnectivity attributes of each network resource component within the network. The descriptive information may be common specifications of the specific component. For example, if the component is an application program interface, it may include the type of communication channels that the application program interface is configured to utilize, the formats, sizes, volume, and context of data that the application program interface is configured to receive and/or process, and the like.

The permissions information may comprise user permissions (e.g., user authentication requirements) associated with the application program interface; device permissions associated (e.g., user device authentication requirements) associated with the application program interface; license or other contract rights, requirements, or limitations associated with the application program interface; software and/or hardware security parameters associated with the application program interface; and the like. The interconnectivity attributes may comprise known data libraries from which the application program interface can or must connect, known hardware or software modules (including third-party hardware or software programs) that are currently connected to the application program interface or which are otherwise compatible with the application program interface, or the like.

In some embodiments, the process 200 includes block 204, where the system receives a request for a new network resource to connect to a first network resource. This request may be a manual request, check, or test by a user associated with the network resource component database. Alternatively, the request may be an automatic request initiated by a new (or modified, updated, or re-located network resource) attempting to connect with, link to, transmit data to, extract data from, monitor, or otherwise interact with a network resource (e.g., a first network resource comprising a software application in the network that is already registered within the network resource component database).

Additionally, in some embodiments, the process 200 includes block 206, where the system determines a component signature of the new network resource. The component signature may comprise a data element (or set of data elements) that represent the component-level make-up of the network resource (e.g., software application). In some embodiments, this component signature comprises a hash that is calculated or determined based on values, statuses, or tiers of component-level information for that network resource. As such, the system may have a set of component-level information that it monitors for each network resource that is stored within the network resource component database. When two network resources (e.g., software applications) are engaging to potentially connect or otherwise interact, the system may use component signatures of each network resource to conduct a handshake process whereby the system is verifying whether the component-specific information embedded within (or otherwise represented by) the component signature of each network resource matches in a manner that indicates that the network resources are compatible with each other.

The step of determining the component signature for the new network resource may comprise compiling network resource component-level specifications for the new network resource into one or more data elements that can be communicated by a handshake process. Although a new (e.g., added) network resource component may not yet have all of its component-specific information or data stored within the network resource component database, the system can extract the component-specific information of the new network resource to generate this component signature in preparation for a handshake procedure with an established and registered network resource of the system.

The process 200 may also include block 208, where the system compares the component signature of the new network resource against a component signature of the first network resource to determine whether the new network resource and the first network resource are compatible within the network. As noted above, comparing the component signatures is a process of checking whether each individual component of the two network resources is compatible with each relevant individual component of the other network resource, at a general functional level, at a software security level, at a user authentication level, and at a device authentication level.

Following block 208, the system, in some embodiments, proceeds to block 210, where in response to determining that the component signature of the new network resource matches the component signature of the first network resource, grants permission to connect the new network resource to the first network resource and store network resource component information for the new network resource in the network resource component database. The system can grant the right to connect the new network resource to the first network resource because a detailed, component-level analysis of the network resources has been conducted by the system to confirm that the two network resources are functionally compatible and meet security and permissions requirements.

Alternatively to block 210, the system may follow block 208 with block 212, where in response to determining that the component signature of the new network resource does not match the component signature of the first network resource, the system (1) rejects the request for the new network resource to connect to the first network resource, and (2) transmits an alert identifying the incompatible network resource components of the new network resource and the first network resource to a computing device of a user associated with the network resource component database.

By prohibiting the new network resource from connecting to, or otherwise interacting with the first network resource, the system provides a heightened amount of security and processing functionality that is based on the component-level analysis of the network resources (instead of on overall network resource-level information). By transmitting an alert to a user device associated with the network resource component database, the system informs users of inappropriate network resource requests within the system network, or otherwise identifies potential complications or barriers to incorporating new network resource components to the overall system. The alert may include specific information regarding the network resources involved, the specific network resource components associated with the incompatibility or permissions-based rejections, proposed resolutions or additional steps needed to achieve compatibility between the network resources, and the like.

In some embodiments, the new network resource comprises a network resource that previously existed on the network, and which has been updated, upgraded, or changed from its previous iteration at a network resource component level. As such, the references to a “new” network resource can also be interpreted as a modified, updated, upgraded, changed or moved network resource that is already known to, registered with, or otherwise associated with the network resource component database.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent applications:

| | U.S. patent | | |
|---|---|---|---|
| | application | | |
| Docket Number | Ser. No. | Title | Filed On |
| 13624US01.014033.4405 | To be assigned | SYSTEMS AND METHODS FOR | Concurrently |
| | | IDENTIFYING AND VERIFYING | herewith |
| | | SOFTWARE COMPONENT STORAGE | |
| | | LOCATIONS IN A NETWORK | |
| | | ENVIRONMENT | |
| 13626US01.014033.4407 | To be assigned | ELECTRONIC SYSTEM FOR | Concurrently |
| | | AUTHENTICATING PERMISSIONS | herewith |
| | | BETWEEN INTERCONNECTED | |
| | | RESOURCES | |
| 13627US01.014033.4408 | To be assigned | ELECTRONIC ARTIFICIAL | Concurrently |
| | | INTELLIGENCE SYSTEM FOR | herewith |
| | | AUTHENTICATING SOFTWARE | |
| 13444US01.014033.4354 | To be assigned | ELECTRONIC SECURITY SYSTEM OF | Concurrently |
| | | NETWORK RESOURCE COMPONENT | herewith |
| | | TRACKING AND ANALYSIS ACROSS | |
| | | A DISTRIBUTED NETWORK AND | |
| | | CONSTRUCTION OF A VALIDATED | |
| | | NETWORK RESOURCE COMPONENT | |
| | | LIBRARY | |
| 13676US01.014033.4421 | To be assigned | ELECTRONIC SYSTEM FOR DYNAMIC | Concurrently |
| | | ADAPTED SECURITY ANALYSIS OF | herewith |
| | | NETWORK RESOURCE COMPONENTS | |
| 13677US01.014033.4422 | To be assigned | DYNAMIC QUARANTINE ENGINE | Concurrently |
| | | INTEGRATION WITH A VALIDATED | herewith |
| | | NETWORK RESOURCE COMPONENT | |
| | | LIBRARY FOR NETWORK SECURITY | |
| 13678US1.014033.4423 | To be assigned | ELECTRONIC SYSTEM FOR | Concurrently |
| | | SECURITY ANALYSIS AND | herewith |
| | | VALIDATION DURING | |
| | | CONSTRUCTION AND DEPLOYMENT | |
| | | OF DYNAMIC NETWORK | |
| | | COMPONENTS | |

What is claimed is:

1. A system for implementing interconnections and authenticating permissions between resource components, the system comprising:
at least one non-transitory storage device; and
at least one processor coupled to the at least one non-transitory storage device, wherein the at least one processor is configured to:
establish a network resource component database comprising, for each network resource associated with the network, network resource component-level specifications and associated component signatures;
receive a request for a new network resource to connect to a first network resource;
determine a component signature of the new network resource; and
compare the component signature of the new network resource against a component signature of the first network resource to determine whether the new network resource and the first network resource are compatible within the network.

2. The system of claim 1, wherein the at least one processor is further configured to:
determine that the component signature of the new network resource matches the component signature of the first network resource; and
in response to determining that the component signature of the new network resource matches the component signature of the first network resource, grant permission to connect the new network resource to the first network resource and store network resource component information for the new network resource in the network resource component database.

3. The system of claim 1, wherein the at least one processor is further configured to:
determine that the component signature of the new network resource does not match the component signature of the first network resource; and
in response to determining that the component signature of the new network resource does not match the component signature of the first network resource,
reject the request for the new network resource to connect to the first network resource; and
transmit an alert identifying the incompatible network resource components of the new network resource and the first network resource to a computing device of a user associated with the network resource component database.

4. The system of claim 1, wherein the network resource component-level specifications comprise descriptive information, permissions information, and known interconnectivity attributes of each network resource component within the network.

5. The system of claim 1, wherein the new network resource comprises a network resource that previously existed on the network, and which has been updated, upgraded, or changed from its previous iteration at a network resource component level.

6. The system of claim 1, wherein the network resource components comprise one or more programs, algorithms, modules, data transfer utilities, device drivers, operating systems, plugins, application program interfaces, web resources, data libraries, data repositories, network resource license right, network resource licensed seat information, network resource version information, network resource patch status information, a physical location of a device associated with network resources, authorized users associated with network resources, and authorized devices associated with network resources.

7. The system of claim 1, wherein determining the component signature for the new network resource comprises compiling network resource component-level specifications for the new network resource into one or more data elements that can be communicated by a handshake process.

8. A computer program product for implementing interconnections and authenticating permissions between resource components, the computer program product comprising a non-transitory computer-readable medium comprising code causing an apparatus to:
establish a network resource component database comprising, for each network resource associated with the network, network resource component-level specifications and associated component signatures;
receive a request for a new network resource to connect to a first network resource;
determine a component signature of the new network resource; and
compare the component signature of the new network resource against a component signature of the first network resource to determine whether the new network resource and the first network resource are compatible within the network.

9. The computer program product of claim 8, wherein the apparatus is further configured to:
determine that the component signature of the new network resource matches the component signature of the first network resource; and
in response to determining that the component signature of the new network resource matches the component signature of the first network resource, grant permission to connect the new network resource to the first network resource and store network resource component information for the new network resource in the network resource component database.

10. The computer program product of claim 8, wherein the apparatus is further configured to:
determine that the component signature of the new network resource does not match the component signature of the first network resource; and
in response to determining that the component signature of the new network resource does not match the component signature of the first network resource,
reject the request for the new network resource to connect to the first network resource; and
transmit an alert identifying the incompatible network resource components of the new network resource and the first network resource to a computing device of a user associated with the network resource component database.

11. The computer program product of claim 8, wherein the network resource component-level specifications comprise descriptive information, permissions information, and known interconnectivity attributes of each network resource component within the network.

12. The computer program product of claim 8, wherein the new network resource comprises a network resource that previously existed on the network, and which has been updated, upgraded, or changed from its previous iteration at a network resource component level.

13. The computer program product of claim 8, wherein the network resource components comprise one or more programs, algorithms, modules, data transfer utilities, device drivers, operating systems, plugins, application program interfaces, web resources, data libraries, data repositories, network resource license right, network resource licensed seat information, network resource version information, network resource patch status information, a physical location of a device associated with network resources, authorized users associated with network resources, and authorized devices associated with network resources.

14. The computer program product of claim 8, wherein determining the component signature for the new network resource comprises compiling network resource component-level specifications for the new network resource into one or more data elements that can be communicated by a handshake process.

15. A method for implementing interconnections and authenticating permissions between resource components, the method comprising:
establishing a network resource component database comprising, for each network resource associated with the network, network resource component-level specifications and associated component signatures;
receiving a request for a new network resource to connect to a first network resource;
determining a component signature of the new network resource; and
comparing the component signature of the new network resource against a component signature of the first network resource to determine whether the new network resource and the first network resource are compatible within the network.

16. The method of claim 15, wherein the method further comprises:
determining that the component signature of the new network resource matches the component signature of the first network resource; and
in response to determining that the component signature of the new network resource matches the component signature of the first network resource, granting permission to connect the new network resource to the first network resource and store network resource component information for the new network resource in the network resource component database.

17. The method of claim 15, wherein the method further comprises:
determining that the component signature of the new network resource does not match the component signature of the first network resource; and
in response to determining that the component signature of the new network resource does not match the component signature of the first network resource,
rejecting the request for the new network resource to connect to the first network resource; and
transmitting an alert identifying the incompatible network resource components of the new network resource and the first network resource to a computing device of a user associated with the network resource component database.

18. The method of claim 15,
wherein the network resource component-level specifications comprise descriptive information, permissions information, and known interconnectivity attributes of each network resource component within the network; and
wherein the network resource components comprise one or more programs, algorithms, modules, data transfer utilities, device drivers, operating systems, plugins, application program interfaces, web resources, data libraries, data repositories, network resource license right, network resource licensed seat information, network resource version information, network resource patch status information, a physical location of a device associated with network resources, authorized users associated with network resources, and authorized devices associated with network resources.

19. The method of claim 15, wherein the new network resource comprises a network resource that previously existed on the network, and which has been updated, upgraded, or changed from its previous iteration at a network resource component level.

20. The method of claim 15, wherein determining the component signature for the new network resource comprises compiling network resource component-level specifications for the new network resource into one or more data elements that can be communicated by a handshake process.
